(19) United States
(12) Patent Application Publication
(10) Pub. No.: US 2019/0234755 A1
(43) Pub. Date: Aug. 1, 2019

(54) Navigation System

(71) Applicant: DENSO International America, Inc., Southfield, MI (US)

(72) Inventors: Yu ZHANG, Farmington Hills, MI (US); Doua VANG, Waterford, MI (US); Vikas UPMANUE, Novi, MI (US); Bilal ALASRY, Dearborn, MI (US); Scott WALENTY, Farmington Hills, MI (US); Laith DAMAN, Novi, MI (US); Gerti TUZI, Ann Arbor, MI (US)

(21) Appl. No.: 15/883,783

(22) Filed: Jan. 30, 2018

(51) Int. Cl. G01C 21/36; G06F 3/0488; G06F 3/0481

(52) U.S. Cl. CPC G01C 21/3614; G06F 3/0481; G06F 3/04883; G01C 21/3664

(57) ABSTRACT

A navigation system having a navigation module configured to plot a first route. A display is controlled by the navigation module to display the first route. A touch surface is configured to receive a touch input by a user corresponding to a second route, which is a modification of the first route, for entry to the navigation module. The navigation module is configured to plot the second route and control the display to display the second route.

### FIELD

The present disclosure relates to a navigation system, such as a navigation system for a vehicle.

### BACKGROUND

This section provides background information related to the present disclosure, which is not necessarily prior art.

Current vehicle navigation systems are suitable for their intended use, but are subject to improvement. For example, existing vehicle navigation systems allow a driver to modify a current route, but the modification process is typically complex. The present disclosure includes improved navigation systems that advantageously allow a driver to modify his/her current route in a manner that is easier, faster, and less distracting as compared to the prior art. The present disclosure provides numerous additional advantages and unexpected results, as explained in detail herein and as one skilled in the art will recognize.

### SUMMARY

This section provides a general summary of the disclosure, and is not a comprehensive disclosure of its full scope or all of its features.

The present disclosure includes a navigation system having a navigation module configured to plot a first route. A display is controlled by the navigation module to display the first route. A touch surface is configured to receive a touch input by a user corresponding to a second route, which is a modification of the first route, for entry to the navigation module. The navigation module is configured to plot the second route and control the display to display the second route.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates an exemplary vehicle including a navigation system in accordance with the present disclosure;

FIG. 2 illustrates an interior of the vehicle of FIG. 1 including an exemplary touchscreen of the navigation system in accordance with the present teachings;

FIG. 3 illustrates the touchscreen displaying a current route, and a user tracing a new route on the touchscreen with his/her finger to modify the current route;

FIG. 4 illustrates the touchscreen displaying a current route, and a user swiping across a portion of the touchscreen with his/her finger to modify the current route;

FIG. 5 illustrates the touchscreen displaying a current route, and a user double tapping on a point of interest with his/her finger to modify the current route to a route that will lead the vehicle to the point of interest; and

FIG. 6 illustrates the touchscreen displaying a current route, and a user swiping vertically on the touchscreen with two of his/her fingers to modify the current route to be a faster or slower route.

Corresponding reference numerals indicate corresponding parts throughout the several views of the drawings.

### DETAILED DESCRIPTION

Example embodiments will now be described more fully with reference to the accompanying drawings.

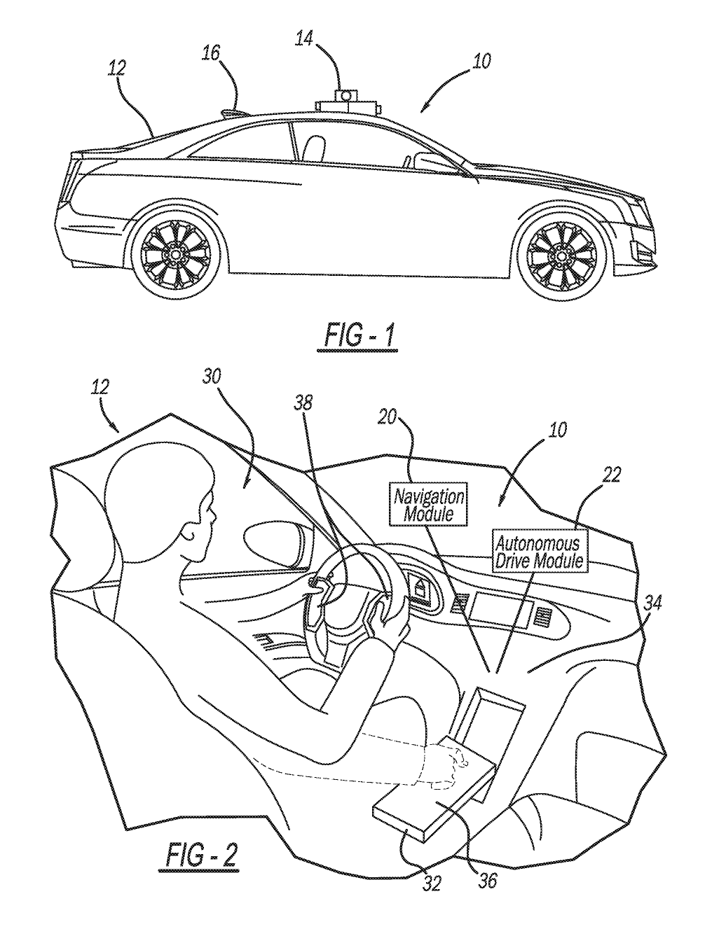

FIG. 1 illustrates a navigation system 10 in accordance with the present disclosure installed within an exemplary vehicle 12. Although the vehicle 12 is illustrated as a passenger vehicle, the navigation system 10 is suitable for use in any vehicle, such as any suitable passenger vehicle, utility vehicle, mass transit vehicle, military vehicle, construction equipment, motorcycle, watercraft, recreational vehicle, etc. The navigation system 10 is also suitable for use with any non-vehicular application. For example, the navigation system 10 can be included with any suitable portable electronic device, such as a tablet computer, laptop computer, smartphone, etc.

The exemplary vehicle 12 includes a plurality of cameras and sensors 14, which can be any array of cameras and sensors suitable for sensing the environment about the vehicle 12 so as to, for example, warn the driver of obstacles about the vehicle 12 and/or for autonomously driving the vehicle 12. The cameras and sensors 14 can include any suitable IR, sonar, LIDAR, radar, etc. sensors and/or cameras. The vehicle 12 further includes a GPS receiver 16 for receiving signals from GPS satellites in order to determine the location of the vehicle 12 and monitor movement of the vehicle 12.

With additional reference to FIG. 2, the navigation system 10 further includes a navigation module 20, and in some applications an autonomous drive module 22. When the navigation system 10 is installed within a vehicle, the navigation module 20 and the autonomous drive module 22 may be located at any suitable position about the vehicle 12. When the navigation system 10 is included with a portable electronic device, the navigation module 20 may be installed in the portable electronic device.

In this application, the term “module” may be replaced with the term “circuit.” The term “module” may refer to, be part of, or include processor hardware (shared, dedicated, or group) that executes code and memory hardware (shared, dedicated, or group) that stores code executed by the processor hardware. The code is configured to provide the features of the modules described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

FIG. 2 illustrates an exemplary passenger cabin 30 of the vehicle 12. The passenger cabin 30 includes a display 32 of the navigation system 10. The display 32 may be mounted at any suitable position about the passenger cabin 30, such as at a center console 34 thereof. In the example illustrated, the display 32 pivots out from, and into, the center console 34. When in use, the display 32 is automatically pivoted out from the center console 34 to a position convenient for operation by the driver. When the display 32 is not in use, it automatically pivots back into the center console 34. When the navigation system 10 is included with a portable electronic device, the display 32 can be a display of the portable electronic device, such as the display of a smartphone, tablet, laptop computer, etc.

The navigation system 10 further includes a touch surface for use by a user to input commands into the navigation module 20. The touch surface can be a touch surface 36 included with the display 32, such as over the display 32, to make the display 32 a touch display. Thus when the navigation system 10 is included with a portable electronic device, the touch surface 36 may be included with the touch screen of the smartphone, tablet, laptop computer, etc. In addition to, or in place of, the touch surface 36, the navigation system 10 may include an additional touch surface 38 spaced apart from the display 32. In the example of FIG. 2, the touch surface 38 is located on a steering wheel of the vehicle 12. The touch surface 38 may alternatively be located at any other suitable position about the passenger cabin 30. The touch surface 38 is mapped to the display 32, which may include an icon (such as a hand icon) that moves across the display in a manner corresponding to movement of the user's finger along the touch surface 38.

The display 32, the touch surface 36, and the touch surface 38 are each in communication with the navigation module 20. Thus using the touch surfaces 36 and/or 38, each of which are mapped to the display 32, the user can input commands to the navigation module 20 instructing the navigation module 20 to plot a first route for the vehicle 12 in any suitable conventional manner known to one skilled in the art. Thus the touch surfaces 36 and/or 38 are configured to accept inputs by the user for navigating the vehicle 12 to any suitable location. The inputs may include a street address or the name of a point of interest, for example. The navigation module 20 will process the address or point of interest and plot a route for the vehicle 12 to the address or point of interest in any suitable conventional manner known to one skilled in the art. The navigation module 20 is configured to control the display 32 to display the plotted route to the driver.

When an autonomous drive module 22 is included, the navigation module 20 is in communication therewith and sends the plotted route to the autonomous drive module 22. The autonomous drive module 22 is configured to operate the vehicle 12 in order to pilot the vehicle 12 along the route to reach the destination input by the user. The autonomous drive module 22 is any suitable autonomous drive module known in the art for autonomously piloting the vehicle 12.

After the first route has been plotted and displayed to the driver on the display 32, the driver can modify the route, select an intermediate destination, and/or select a new destination by entering a touch input to the touch surface 36 or the touch surface 38. The touch input may be any suitable gesture, which advantageously alleviates any need for the user to enter a physical address, specific name of a point of interest, or specific road names that the user wishes to follow. As a result, the user can modify the first route with increased simplicity and speed, and with less distraction. Any suitable gestures may be used including, but not limited to, those described below.

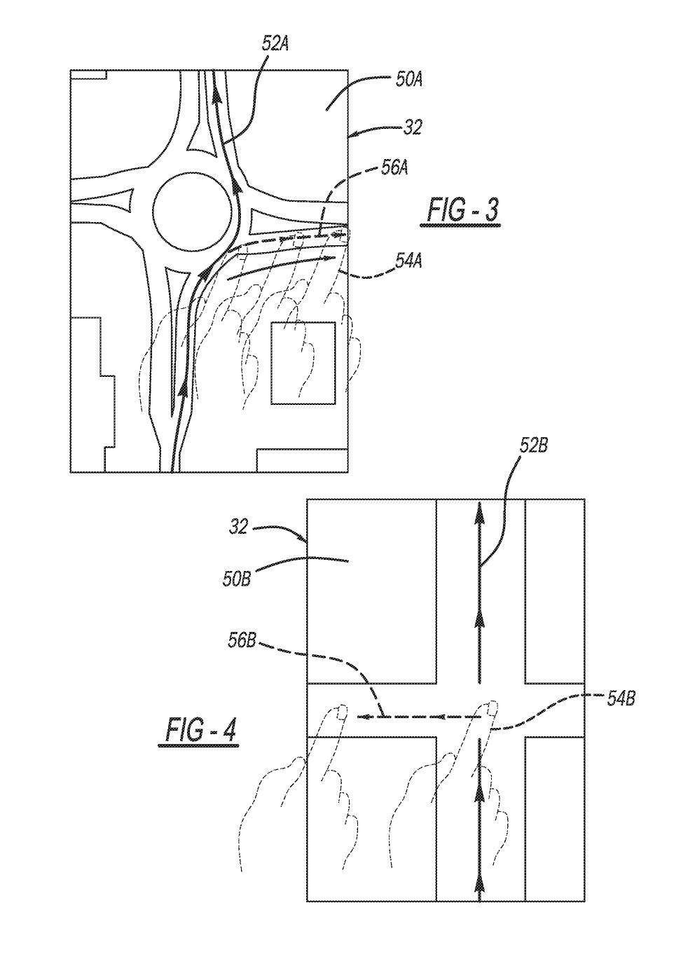

FIG. 3 illustrates an exemplary map 50A displayed by the display 32, as controlled by the navigation module 20. A current (or first) route is displayed on the map 50A by first route line 52A. To replace/modify the first route with a second route, the user merely traces his or her finger 54A along the portions of the map 50A corresponding to the new route desired by the user. Thus the touch surfaces 36/38 are configured to sense the trace of the user's finger 54A and input data corresponding to the trace to the navigation module 20. The navigation module 20 then processes the data to identify the second route desired by the user, plots the second route, and controls the display 32 to display the second route using route line 56A. The second route 56A may lead to the same destination as the first route 52A, or any other suitable destination. When the system 10 includes the autonomous drive module 22, the navigation module 20 can input the second route to the autonomous drive module 22 for use by the autonomous drive module 22 to pilot the vehicle 12 along the second route 56A.

FIG. 4 illustrates an additional way to replace/modify the first route in accordance with the present disclosure. The navigation module 20 is further configured to receive data from the touch surfaces 36 and/or 38 corresponding to user touch input in the form of hand swipes on the map 50B. For example, if the vehicle 12 is at or approaching an intersection and the user desires to make a left turn instead of following the first route 52B straight through the intersection, the user may input a request for a second route 56B by swiping his/her finger 54B left at the intersection. The navigation module 20 receives data representing the touch inputs in form of the hand swipes, and plots the second route 56B accordingly. The navigation module 20 then controls the display 32 to display the second route 56B, and instructs the optional autonomous drive module 22 to pilot the vehicle 12 along the second route 56B. The second route 56B may lead to the same destination as the first route 52B, or any other suitable destination.

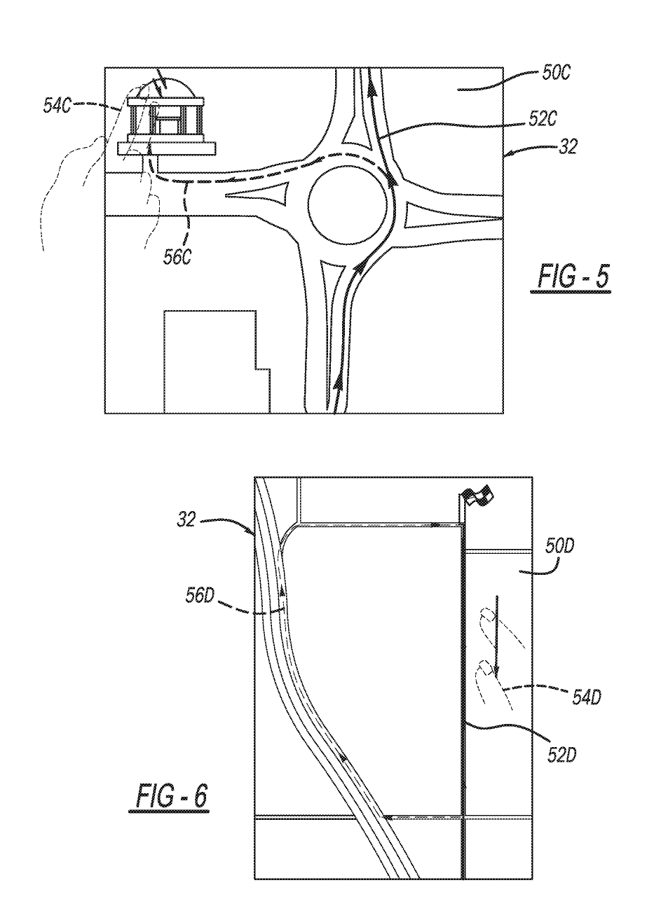

With reference to FIG. 5, the navigation system 10 is further configured to plot the second route 56C in response to a touch input in the form of a tap (such as a double tap 54C) on a place of interest that is not along the first route 52C. Data corresponding to the tap at the touch surface 36 and/or 38 is input to the navigation module 20, which identifies the place of interest corresponding to the location on the map 50C where the tap took place. In the example of FIG. 5, the fingers 54C are tapping on a museum. After reaching the museum, the navigation module 20 can be configured to plot a route to the destination of the first route 52C. The navigation module 20 then plots the second route 56C to the museum. Thus the present teachings advantageously eliminate the need for the user to manually enter the name of the place of interest (e.g., museum, ballpark, stadium, airport, etc.).

With reference to FIG. 6, the navigation system 10 is further configured to plot the second route 56D in response to touch inputs in the form of double finger drags, such as from top to bottom of the display 32, or bottom to top of the display 32. The navigation module 20 is configured to process data corresponding to such touch inputs in any suitable manner. For example, the navigation module 20 is configured to process a double finger drag 54D from top to bottom of the display 32 to represent a command by the user requesting a second route that is faster than the first route 52A; and process a double finger drag 54D from the bottom to the top as a command by the user for a second route that is slower than the first route. The navigation module 20 is configured to plot a slower or faster route on the map 50D accordingly, and operate the display 32 to display the faster or slower second route, as well as send the second route to the autonomous drive module 22 for use by the autonomous drive module 22 to pilot the vehicle 12. When the user desires a second route that is faster than the first route 52D and the first route 52D is along surface streets (see FIG. 6, for example), the navigation module 20 may plot the second route 56D along an expressway that will result in the vehicle 12 reaching the destination faster, but require additional mileage.

The present teachings advantageously provide for a navigation system 10 that allows a driver/operator to input a route change with a touch input (such as a simple touch or gesture command) using a touch surface, such as touch surface 36 at the display 32 or touch surface 38 at a steering wheel (or any other suitable positions spaced apart from the display). The navigation system 10 advantageously eliminates the need for a driver/operator to input a specific address or other detailed route information to modify a current route, which increases the complexity of the navigation system, and may distract the driver/operator. The present disclosure provides numerous additional advantages and unexpected results, as one skilled in the art will appreciate.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A navigation system comprising:
a navigation module configured to plot a first route;
a display controlled by the navigation module to display the first route; and
a touch surface configured to receive a touch input by a user corresponding to a second route, which is a modification of the first route, for entry to the navigation module;
wherein the navigation module is configured to plot the second route and control the display to display the second route.

2. The navigation system of claim 1, wherein the touch input is a gesture.

3. The navigation system of claim 1, wherein the touch surface is included with the display.

4. The navigation system of claim 1, wherein the touch surface is spaced apart from the display.

5. The navigation system of claim 4, wherein the touch surface is at a steering wheel of the vehicle.

6. The navigation system of claim 1, wherein the touch input is a trace along at least a portion of the second route by the user using his/her finger on a map displayed by the display surface.

7. The navigation system of claim 1, wherein the touch input is a swipe corresponding to at least a portion of the second route on a map displayed by the display surface.

8. The navigation system of claim 1, wherein the touch input is a tap on a destination of the second route displayed by the display surface; and
wherein the navigation module is configured to plot the second route to the destination and control the display to display the second route to the destination.

9. The navigation system of claim 8, wherein subsequent to reaching the destination of the second route, the navigation module operates the display module to display navigation to a destination of the first route.

10. The navigation system of claim 1, wherein the touch input is a two-finger drag by the user on a map displayed by the display surface; and
wherein the navigation module is configured to plot the second route and control the display to display the second route to a destination, the second route calculated by the navigation module to be faster than, or slower than, the first route to the destination.

11. The navigation system of claim 1, further comprising an autonomous drive module;
wherein the navigation module is in communication with the autonomous dive module to input the first route and the second route to the autonomous drive module for the autonomous drive module to drive the vehicle along a portion of the first route and then the second route.

12. A method for navigating a vehicle, the method comprising:
plotting with a navigation module a first route to a destination requested by a user;
displaying the first route on a display;
plotting with the navigation module a second route that is a modification of the first route and is entered by the user with a touch input at a touch surface; and
displaying the second route on the display.

13. The method of claim 12, wherein the touch input is a gesture.

14. The method of claim 12, wherein the touch surface is included with the display.

15. The method of claim 12, wherein the touch surface is spaced apart from the display.

16. The method of claim 12, wherein the touch input is a trace along at least a portion of the second route by the user using his/her finger on a map displayed by the display surface.

17. The method of claim 12, wherein the touch input is a swipe along at least a portion of the second route by the user using his/her finger on a map displayed by the display surface.

18. The method of claim 12, wherein the touch input is a tap on a destination of the second route by the user using his/her finger on a map displayed by the display surface; and
wherein the navigation module plots the second route to the destination and controls the display to display the second route to the destination.

19. The method of claim 12, wherein the touch input is a two-finger drag by the user along a map displayed by the display surface; and
wherein the navigation module plots the second route to the destination and controls the display to display the second route, the second route calculated by the navigation module to be faster than the first route to the destination.

20. The method of claim 12, wherein the navigation module is in communication with an autonomous drive module to input the first route and the second route to the autonomous drive module for the autonomous drive module to drive the vehicle along a portion of the first route and then the second route.
